(19) United States
(12) Patent Application Publication
(10) Pub. No.: US 2019/0297269 A1
(43) Pub. Date: Sep. 26, 2019

(54) CONTROL APPARATUS, IMAGING APPARATUS, AND CONTROL METHOD

(71) Applicant: CANON KABUSHIKI KAISHA, Tokyo (JP)

(72) Inventor: Kengo Takeuchi, Kawasaki-shi (JP)

(21) Appl. No.: 16/363,244

(22) Filed: Mar. 25, 2019

(30) Foreign Application Priority Data
Mar. 26, 2018 (JP) 2018-058643

(51) Int. Cl. H04N 5/232

(52) U.S. Cl. CPC H04N 5/232122; H04N 5/23267; H04N 5/232123

(57) ABSTRACT

A control apparatus includes a focus detector configured to perform a focus detection by a phase difference method based on an image signal output from an image sensor, a driver configured to change a relative position between an imaging optical system and the image sensor in a direction orthogonal to an optical axis in the imaging optical system, and a controller configured to control the focus detector and the driver so as to perform the focus detection by changing the relative position between the imaging optical system and the image sensor to each of a first position and a second position.

### BACKGROUND OF THE INVENTION

### Field of the Invention

The present invention relates to a control apparatus that provides a focus detection.

### Description of the Related Art

Japanese Patent Laid-Open No. (“JP”) 58-24105 discloses a focus detection apparatus that provides a focus detection using a two-dimensional image sensor (image pickup element) that includes a micro lens for each pixel, and a phase difference in a pixel divided by a so-called pupil dividing method. The focus detection apparatus disclosed in JP 58-24105 can detect a focus state by dividing a photoelectric convertor in each pixel into a plurality of portions, and by receiving through the divided photoelectric convertors and the micro lens light fluxes that have passed mutually different areas on the pupil in the imaging optical system. JP 2016-71275 discloses an imaging apparatus that performs a focus detection using a contrast autofocus (AF) that performs a focus detection by evaluating the contrast of image data, in addition to the phase difference AF.

In the focus detection apparatus disclosed in JP 58-24105, a signal used for the phase difference AF is a signal corresponding to an area thinned from the entire image, and thus information useful for the phase difference AF, such as a high-contrast edge region, may exist in the thinned area. Then, the focus detection cannot be accurately performed with the phase difference AF.

The imaging apparatus disclosed in JP 2016-71275 performs the focus detection using both the phase difference AF and the contrast AF, but the contrast AF may require a long focusing time and may not achieve a high speed focus detection.

### SUMMARY OF THE INVENTION

The present invention provides a control apparatus, an imaging apparatus, and a control method, which can provide an accurate and fast focus detection.

A control apparatus according to one aspect of the present invention includes a focus detector configured to perform a focus detection by a phase difference method based on an image signal output from an image sensor, a driver configured to change a relative position between an imaging optical system and the image sensor in a direction orthogonal to an optical axis in the imaging optical system, and a controller configured to control the focus detector and the driver so as to perform the focus detection by changing the relative position between the imaging optical system and the image sensor to each of a first position and a second position.

An imaging apparatus according to another aspect of the present invention includes an image sensor, a focus detector configured to perform a focus detection by a phase difference method based on an image signal output from the image sensor, a driver configured to change a relative position between an imaging optical system and the image sensor in a direction orthogonal to the optical axis of the imaging optical system, and a controller configured to control the focus detector and the driver so as to perform the focus detection by changing the relative position between the imaging optical system and the image sensor to each of a first position and a second position.

A control method according to another aspect of the present invention includes the steps of changing a relative position between an imaging optical system and an image sensor, and changing the relative position in a direction orthogonal to an optical axis in the imaging optical system to each of a first position and a second position and performing a focus detection by a phase difference method based on an image signal output form the image sensor.

Further features of the present invention will become apparent from the following description of exemplary embodiments with reference to the attached drawings.

### BRIEF DESCRIPTION OF THE DRAWINGS

FIG. 1 is a block diagram of an imaging apparatus according to each embodiment.

FIG. 2 illustrates a pixel configuration of an image sensor in each embodiment.

FIG. 3 illustrates a positional relationship between a sensor plane on the image sensor and an imaging range of exit light in each embodiment.

FIG. 4 illustrates a relationship between an AF frame, an object, and a phase difference detecting line in each embodiment.

FIG. 5 illustrates a phase difference detecting line and a contrast evaluating line in each embodiment.

FIGS. 6A and 6B explain an operation mode A in each embodiment.

FIGS. 7A to 7D explain an operation mode B in each embodiment.

FIG. 8 is a flowchart of timing determination processing according to a second embodiment.

FIG. 9 is a flowchart of an AF control in each embodiment.

FIG. 10 is a flowchart of focus detection processing according to a first embodiment.

FIG. 11 is a flowchart of determination processing of a shift lens driving amount in each embodiment.

FIG. 12 is a flowchart of focus detection processing according to the second embodiment.

### DESCRIPTION OF THE EMBODIMENTS

Referring now to the accompanying drawings, a detailed description will be given of embodiments according to the present invention.

### First Embodiment

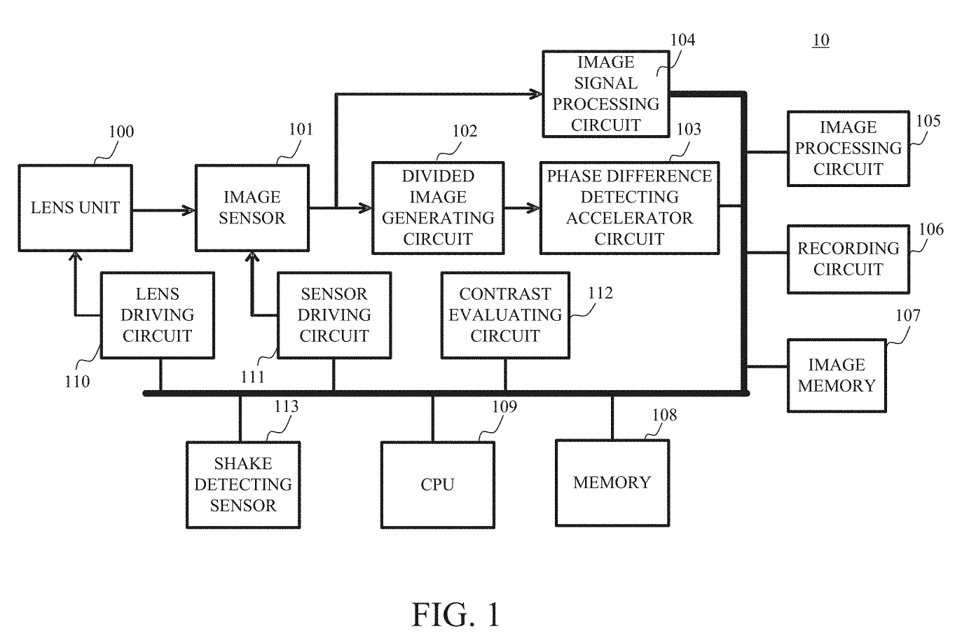

Referring now to FIG. 1, a description will be given of a configuration of an imaging apparatus according to a first embodiment of the present invention. FIG. 1 is a block diagram of an imaging apparatus 10. The lens unit (imaging optical system) 100 includes a focus lens, a zoom lens, a diaphragm (aperture stop), a shift lens for an optical image stabilization (used to correct a camera shake), and the like. The image sensor (imaging element) 101 is a CMOS sensor or a CCD sensor, and photoelectrically converts an image (optical image) of an object formed via the lens unit 100 and outputs an image signal (image data). In this embodiment, the image sensor 101 outputs the image signal obtained by dividing the light flux having passed through the pupil (exit pupil) in the lens unit 100 into two or left and right images. This embodiment configures the lens unit 100 integrally with the imaging apparatus 10, but the present invention is not limited to this embodiment. The lens unit 100 may be configured to be attachable to and detachable from an imaging apparatus body including the image sensor 101.

A divided image generating circuit 102 generates two divided images (divided images) based on the output signal from the image sensor 101. A phase difference detecting accelerator circuit 103 performs processing for correcting an optical distortion in each of the two images (divided images) generated by the divided image generating circuit 102, and a correlation calculation (focus detection) for detecting the phase difference between the two images. In other words, the phase difference detecting accelerator circuit 103 constitutes a focus detector configured to perform the focus detection by the phase difference method based on the image signal output from the image sensor 101 which photoelectrically converts the optical image formed via the lens unit 100. The output signal from the phase difference detecting accelerator circuit 103 is written in the memory 108.

An image signal processing circuit 104 combines the two images (image signals) output from the image sensor 101 to generate a video signal, and performs plural optical correction processing, electric noise processing, and the like for the generated video signal. An image memory 107 temporarily stores the video signal generated by the image signal processing circuit 104. An image processing circuit 105 converts the video signal into a predetermined video data format. A recording circuit 106 records an image in a recording medium (not shown).

A contrast evaluating circuit (contrast evaluator) 112 evaluates the contrast state in a plurality of predetermined areas in the video signal temporarily stored in the image memory 107. A shake detecting sensor 113 detects vibration information (shake information) of the imaging apparatus 10. A sensor driving circuit (driver) 111 changes the position of the image sensor 101 (the relative position between the image sensor 101 and the lens unit 100) in order to perform image stabilization processing and high-resolution processing. A CPU 109 governs controls over a variety of circuits in the imaging apparatus 10, a focus control, a lens driving control, and the like. A memory 108 stores a program and data used for the CPU 109. A lens driving circuit (driver) 110 drives the focus lens, the zoom lens, the diaphragm, the shift lens, and the like in the lens unit 100. Signal processing (focus detection processing), which will be described later in this embodiment, is mainly executed by the CPU 109 and the phase difference detecting accelerator circuit 103. The control apparatus according to this embodiment includes at least the CPU 109 and the phase difference detecting accelerator circuit 103.

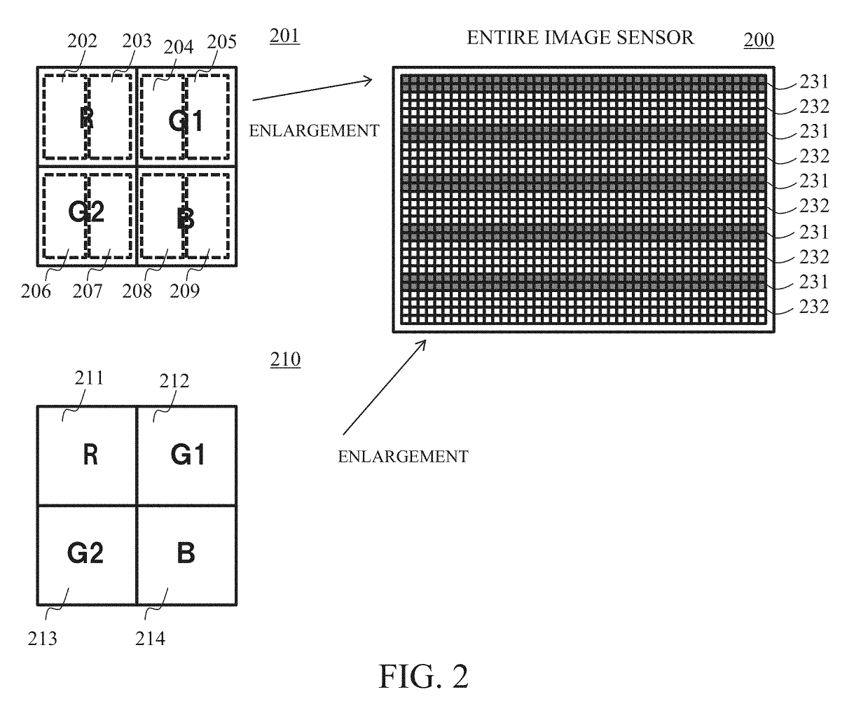

Referring now to FIG. 2, a description will be given of a pixel configuration of the image sensor 101. FIG. 2 illustrates a pixel configuration in the image sensor 101. FIG. 2 illustrates the entire image sensor 101 two blocks (areas) 201 and 210 as cut and enlarged part of the image sensor 101. Each dark gray band indicated in the entire image sensor 101 is a line (phase difference detecting line) 231 that serves as an image-plane phase difference detecting pixel and an image generating pixel, and its partial area corresponds to the block 201. Each light gray band in the entire image sensor 101 is a line 232 used only to generate an image without performing an image-plane phase difference detection, and its part corresponds to the block 210.

The image sensor 101 is a Bayer array type image sensor, and each pixel on the phase difference detecting line has two divided photoelectric conversion elements for each RGB pixel which share one micro lens. For example, the R pixel is halved into an A image pixel (first pixel) 202 and a B image pixel (second pixel) 203. Hereinafter, the images (image signals) output from the A image pixel 202 and the B image pixel 203 will be referred to as A image (A image signal) and B image (B image signal), respectively. Similarly, each of the G pixel (G1 pixel, G2 pixel) and the B pixel is also halved into a corresponding one of the A image pixels 204, 206, and 208 and a corresponding one of the B image pixels 205, 207, and 209.

The imaging apparatus 10 using the thus-configured image sensor 101 can generate an image signal R as in prior art to be recorded or processed by combining (or adding) the A image output from the A image pixel 202 and the B image output from the B image pixel 203. In addition, the imaging apparatus 10 obtains an original signal used for the focus detection (phase difference detection) by separately treating the A image pixel 202 and the B image pixel 203 as two images or left and right divided images (two divided images). On the other hand, each RGB pixel has a single photoelectric conversion element for a single micro lens in the block used only for the image generation, and the block includes the R pixel 211, the G1 pixel 212, the G2 pixel 213, and the B pixel 214.

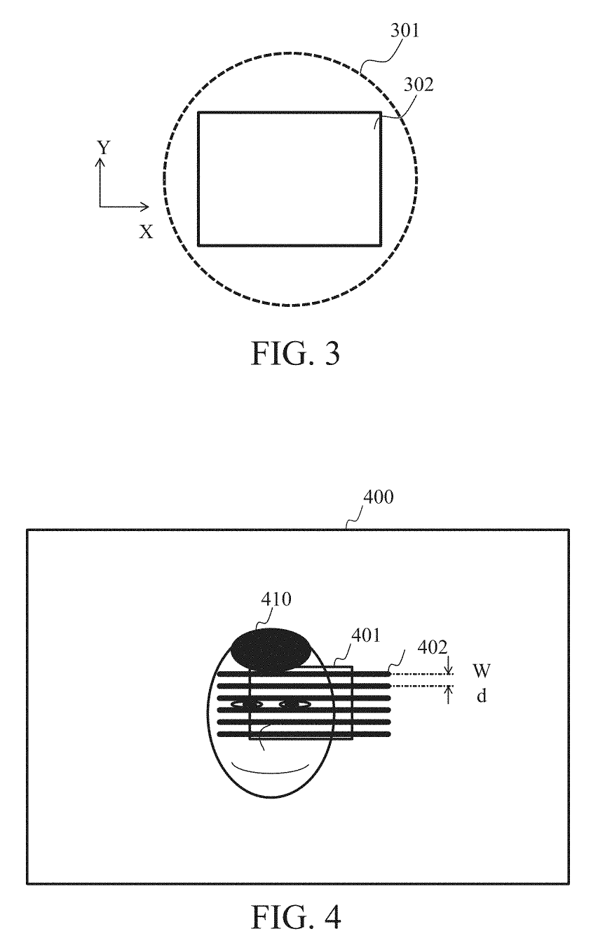

FIG. 3 illustrates a positional relationship (projection state) between the sensor plane 302 of the image sensor 101 and an imaging range 301 of an image formed by the exit light from the lens unit 100. The relative positional relationship between the imaging range 301 and the sensor plane 302 can be changed by moving (driving) the shift lens in the lens unit 100 in the x direction or the y direction through the lens driving circuit 110 (or a direction orthogonal to the optical axis (optical-axis orthogonal direction)). The relative positional relationship can also be changed by driving (moving) the image sensor 101 in the x direction or the y direction (optical-axis orthogonal direction) through the sensor driving circuit 111. In other words, the lens driving circuit 110 or the sensor driving circuit 111 can change the relative positional relationship between the imaging range 301 and the sensor plane 302 by a predetermined amount (specified amount) in the optical-axis orthogonal direction.

FIG. 4 illustrates a relationship between an AF frame, an object, and the phase difference detecting lines. A frame 400 illustrates an entire angle of field that can be captured by the imaging apparatus 10. There are illustrated a face (object) 410 of a person, an AF frame 401, and a plurality of phase difference detecting lines 402 with a thick solid line in this scene. The plurality of phase difference detecting lines 402 are thinned out and arranged at regular intervals Wd in the vertical direction. The imaging apparatus 10 according to this embodiment makes an evaluation in the AF frame 401 in accordance with a predetermined separation classification.

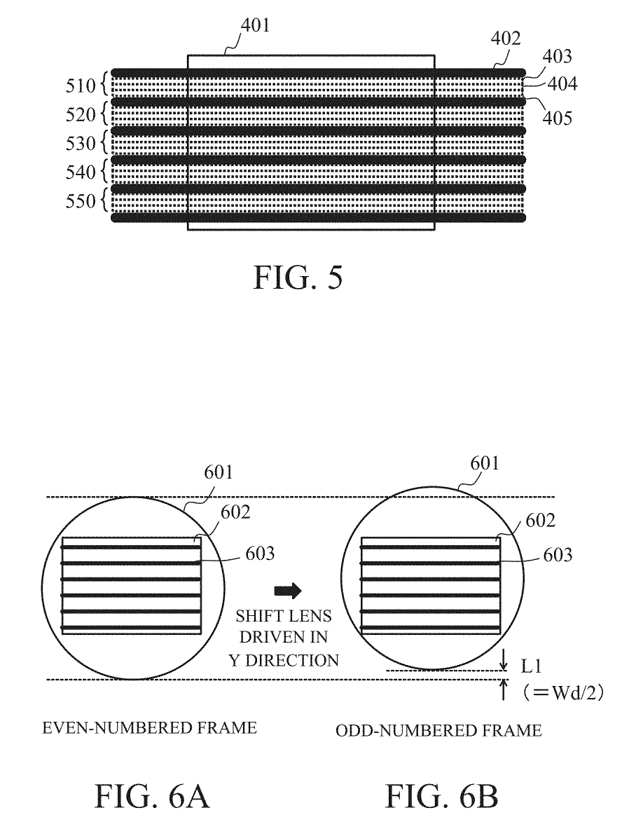

FIG. 5 illustrates the phase difference detecting lines and contrast evaluating lines. In addition to the AF frame 401 and the phase difference detecting lines 402 illustrated in FIG. 4, FIG. 5 illustrates that an area between two adjacent phase difference detecting lines is equally divided into three parts equivalent with the width of the phase difference detecting line, and divided into three into areas (lines) 403 to 405 from the top. In other words, an area 510 in FIG. 5 has four areas or the phase difference detecting line 402 and the areas 403 to 405, and the AF frame 401 has five areas 510 to 550 each having the same configuration as that of the area 510. The contrast evaluating circuit 112 performs the contrast evaluation based on the undivided image information of each of these lines.

Specifically, one evaluation value is generated by integrating the contrast evaluation value (such as a peak value after predetermined filtering and a line direction integrated value of an adjacent difference) obtained by the phase difference detecting line 402 in each of the areas 510 to 550. Similarly, one evaluation value is generated by integrating the contrast evaluation value obtained in the area 403 in each of the areas 510 to 550. One evaluation value is generated by integrating the contrast evaluation value obtained in the area 404 in each of the areas 510 to 550. One evaluation value is generated by integrating the contrast evaluation value obtained in the area 405 in each of the areas 510 to 550. Therefore, four contrast evaluation values are generated in the AF frame 401.

Next follows a description of the operation of the imaging apparatus 10 according to this embodiment. When the imaging apparatus 10 runs and the lenses, circuits, and the like are initialized in predetermined initialization processing, an image signal is taken from the image sensor 101. When a signal (image signal) for developments to record or display an image is input to the image signal processing circuit 104, the phase difference detecting pixel first adds the A image and the B image to each other (or generates an added signal), as if they are treated as one pixel (because normal non-shared pixels are not added) as in the prior art. Then, the image signal processing circuit 104 performs optical correction processing and electrical correction processing for the added signal, and temporarily stores it in the image memory 107. For example, when it is recorded as a captured image, the added signal is converted into a predetermined format (motion image or still image format such as MPEG 2, MP 4, JPG, etc.) via the image processing circuit 105 and the image memory 107, and recorded in the recording medium through the recording circuit 106.

The image information for the specified AF frame and specified area read out of the image memory 107 is input into the contrast evaluating circuit 112, the contrast is evaluated, and then the contrast evaluation result is recorded in the memory 108. On the other hand, the output signal from the phase difference detecting pixel is input from the image sensor 101 to the divided image generating circuit 102 for the focus detection (phase difference detection) and receives the compression processing and correction processing based on predetermined settings, and the A and B images are generated. Herein, two pixels are added in the horizontal direction and two pixels are added in the vertical direction for each of the A image and the B image and the result is sent to the phase difference detecting accelerator circuit 103 as addition result data for RG(G1, G2)B. The phase difference detecting accelerator circuit 103 performs a correlation calculation for the phase difference detection, and the calculation result is temporarily output to the memory 108. The CPU 109 performs final processing for the calculation result and detects the defocus amount of the focus lens.

Referring now to FIG. 9, a description will be given of the AF control of the imaging apparatus 10. FIG. 9 is a flowchart of the AF control. Each step in FIG. 9 is mainly executed by the CPU 109.

First, in the step S901, when receiving an instruction to start the AF operation (AF trigger) by half-pressing the release button or the like, the CPU 109 proceeds to the step S902. In the step S902, the CPU 109 sets an AF frame of a predetermined frame size at a position specified by the user, such as one center point. Next, in the step S903, the CPU 109 performs the focus detection processing on the AF frame (specified frame) set in the step S902. The details of the focus detection processing will be described later.

Next, in the step S904, the CPU 109 calculates a focus lens driving amount based on the focus detection data (defocus amount obtained by the focus detection processing) on the specified frame. For example, if the nearly in-focus state is determined based on the obtained defocus amount, the CPU 109 determines as the defocus amount itself the lens driving amount as an amount to move the focus lens to the in-focus position, and obtains the in-focus state in the next lens driving. On the other hand, when the defocus amount is, for example, about 2 mm or more causing a blurred area, the CPU 109 makes a determination and calculation such as setting the driving amount to about 1 mm because the focus detection accuracy slightly deteriorates, and determines the lens driving amount. Next, in the step S905, the CPU 109 drives the lens using the lens driving circuit 110 based on the lens driving amount determined in the step S904.

Next, in the step S906, if the CPU 109 determines that the lens is in-focus by the lens driving in the step S905, the CPU 109 proceeds to the step S907 and ends the AF control. On the other hand, if the CPU 109 determines that the lens is not in-focus by the lens driving in the step S905 (in an out-of-focus state), the CPU 109 returns to the step S903 and repeats the steps S903 to S906.

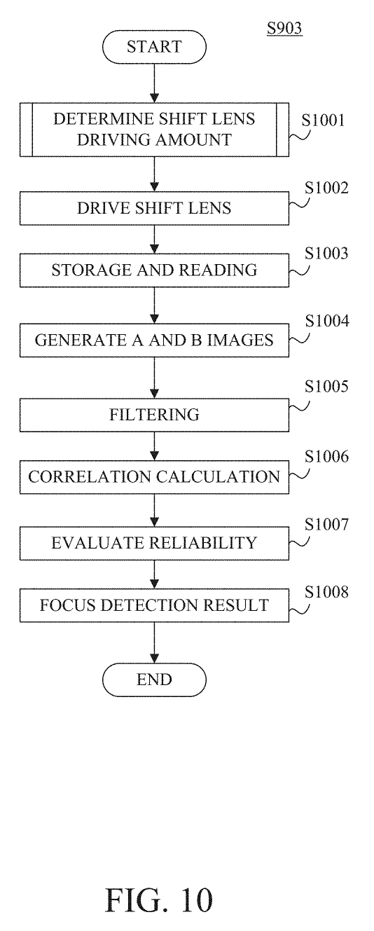

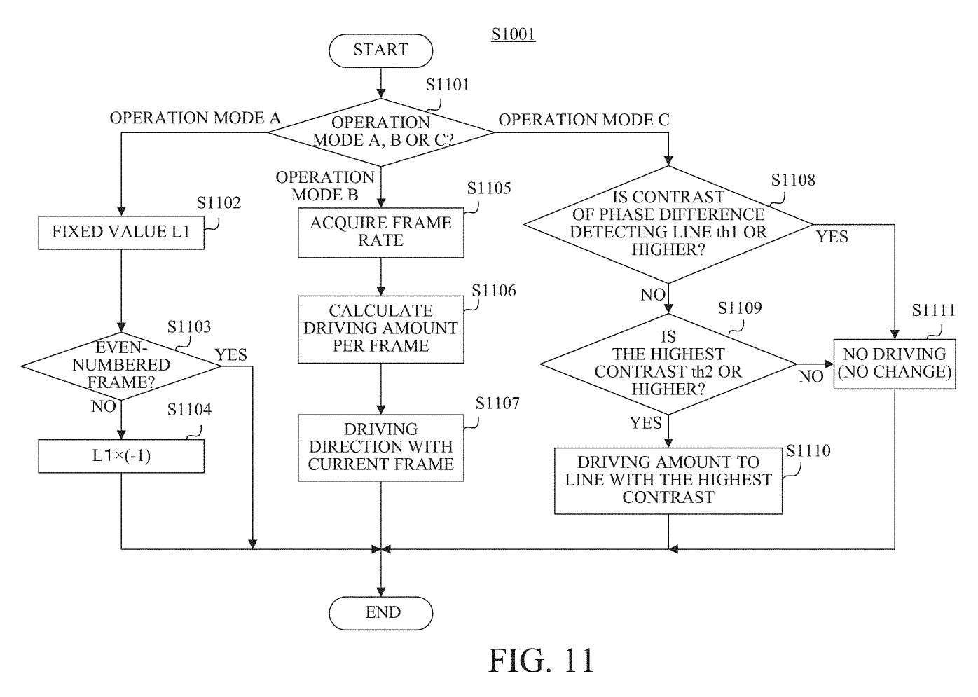

Referring now to FIGS. 10 and 11, a description will be given of the focus detection processing (in the step S903 in FIG. 9) on the specified frame. FIG. 10 is a flowchart of the focus detection processing. FIG. 11 is a flowchart of determination processing of a shift lens driving amount (step S1001 in FIG. 10). Each step in FIGS. 10 and 11 is mainly executed by the CPU 109.

First, in the step S1001 in FIG. 10, the CPU 109 determines the drive amount of the shift lens in the lens unit 100. Referring to FIG. 11, a detailed description will be given of the determination processing of the shift lens driving amount. First in the step S1101, the CPU 109 determines the operation mode and switches the processing in accordance with the operation mode.

An operation mode A (first mode) is a wobbling or reciprocating mode with a fixed amount in which the imaging apparatus 10 is physically fixed, and used for a searching operation for an object with focus detection frames at multiple points or the like. An operation mode B (second mode) is a mode that changes the shift lens driving amount in accordance with the frame rate, and is mainly used for a high frame rate of the imaging apparatus 10. An operation mode C (third mode) is used for the defocus state, gives priority to the recorded image quality, and switches the driving amount based on the phase difference focus detection result and the image contrast evaluation result. This embodiment performs different focus detection processing as follows based on the three operation modes A, B, and C. However, this embodiment is not limited to these operation modes, and may have another operation mode. The operation mode may be selected by the CPU 109 in accordance with a user operation on an unillustrated operation unit, or the CPU 109 may select an operation mode suitable for a determination result of determining a scene based on the image signal.

In the operation mode A, the flow proceeds to the step S1102, and the CPU 109 selects a fixed value L1 as a shift lens driving amount. The fixed value L1 can be arbitrarily set, for example, may use a value that is half the interval between the phase difference detecting lines. Next, in the step S1103, the CPU 109 determines whether or not the image frame used for the focus detection is an even-numbered frame. When the image frame is an even-numbered frame, the shift lens driving amount is maintained at the fixed value L1, and this flow ends. On the other hand, when the image frame is an odd-numbered frame, the flow ends by setting the shift lens driving amount to a driving amount (L1×(−1)) by inverting the sign of the fixed value L1. Thereby, the shift lens wobbles or reciprocates with a width of the fixed value L1 in a frame unit. In other words, the relative position between the imaging optical system and the imaging apparatus is changed to each of the first position and the second position. Referring now to FIGS. 6A and 6B, a description will be given of the wobbling operation (operation mode A) having the width of the fixed value L1.

FIGS. 6A and 6B explain the operation mode A, FIG. 6A illustrates an even-numbered frame, and FIG. 6B illustrates an odd-numbered frame. In FIGS. 6A and 6B, reference numeral 601 denotes the image plane of the exit light from the lens unit 100, reference numeral 602 denotes the sensor plane of the image sensor 101, and reference numeral 603 denotes the phase difference detecting line. As illustrated in FIGS. 6A and 6B, the odd-numbered frame and the even-numbered frame shift from each other in the Y direction (vertical direction in FIGS. 6A and 6B) by half (=Wd/2) the interval Wd between the phase difference detecting lines 603 (or the fixed value L1 is equal to Wd/2).

On the other hand, if the operation mode B is selected in the step S1101 in FIG. 11, the flow proceeds to the step S1105 and the CPU 109 acquires the frame rate. Next, in the step S1106, the CPU 109 calculates the driving amount (shift lens driving amount) per frame. In this embodiment, the CPU 109 make a calculation to reciprocate the shift lens position (shift position) at 30 frames/second. For example, at a reading/recording rate of 120 frames/second, since it returns by 4 (120/30=4) reciprocating motion, it is calculated as two steps or as dividing the phase difference detecting line into three. Assume that FrameRate is the frame rate and Wd is the interval between the phase difference detecting lines. Then, the driving amount hs (shift lens driving amount) is expressed by the following expression (1).

Hs=Wd/((FrameRate/30)/2+1) (1)

If FrameRate/30 is an odd number in the expression (1), 1 is subtracted from it in order to round it into an even number. Next, in the step S1107, the CPU 109 calculates the driving direction with the current frame, and ends this flow.

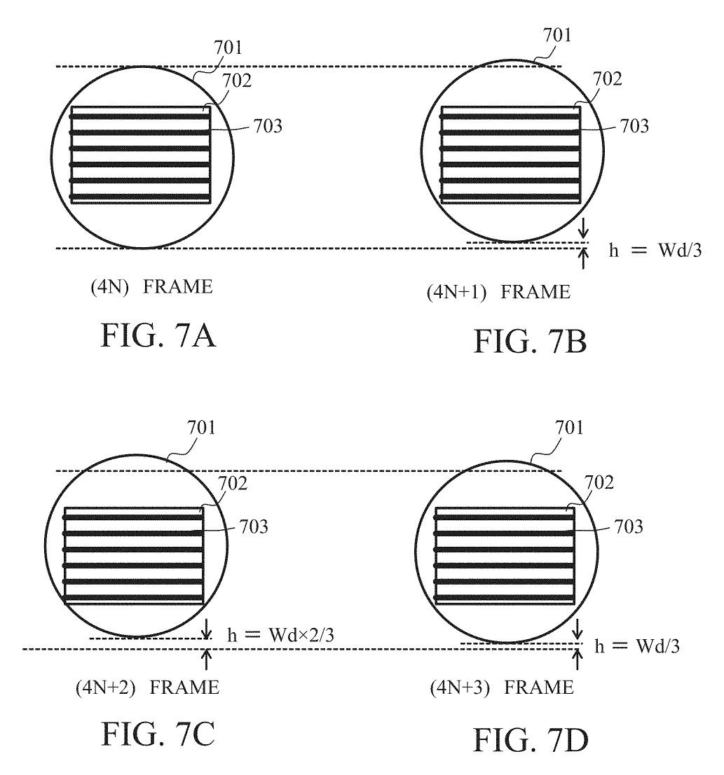

FIGS. 7A to 7D explain the operation mode B with 120 frames/second. FIG. 7A illustrates a (4N)-th frame, FIG. 7B illustrates a (4N+1)-th frame, FIG. 7C illustrates a (4N+2)-th frame, and FIG. 7D illustrates a (4N+3)-th frame, respectively. In FIGS. 7A to 7D, reference numeral 701 denotes the image plane of the exit light from the lens unit 100, reference numeral 702 denotes the sensor plane of the image sensor 101, and reference numeral 703 denotes the phase difference detecting line. As a result of the above calculation, a single moving amount is Wd/3 and FrameRate/30=4, which means that four operations result in one reciprocation. Two of the four different relative positions in the four operations correspond to the first position and the second position. Thus, as illustrated in FIGS. 7A to 7D, the driving direction is changed by the remainder value obtained by dividing the frame counter by 4.

When the operation mode C is selected in the step S1101 in FIG. 11, the flow proceeds to the step S1108. In the step S1108, the CPU 109 determines whether or not the contrast (contrast evaluation result) of the phase difference detecting line is equal to or higher than the contrast th1 (predetermined contrast). When the contrast of the phase difference detecting line is equal to or higher than the contrast th1, the flow proceeds to the step S1111. In the step S1111, the CPU 109 provides a control so as not to drive the shift lens (or sets the drive amount to 0).

When the contrast of the phase difference detecting line is lower than the contrast th1 in the step S1108, the flow proceeds to the step S1109. In the step S1109, the CPU 109 extracts a line that provides the maximum contrast evaluation value among the three areas (lines) other than the phase difference detecting line, which is equal to or higher than the contrast th2. In other words, the CPU 109 determines whether or not there is the highest contrast line equal to or higher than the contrast th2.

If there is no line with the contrast th2 or higher in the step S1109, since the contrast is low in any of the lines, the flow proceeds to the step S1111 and the CPU 109 sets the driving amount to zero. On the other hand, if there is the line having the contrast th2 or higher in the step S1109, the flow proceeds to the step S1110. In the step S1110, the CPU 109 sets the driving amount from the current state to that line (having the contrast th2 or higher), and ends this flow.

When the shift lens driving amount in the step S1001 in FIG. 10 is determined in accordance with each operation mode through the above processing, the flow proceeds to the step S1002. In the step S1002, the CPU 109 drives the shift lens based on the determined driving amount using the lens driving circuit 110 although the shift lens is not driven when the driving amount is zero. Next, in the step S1003, the CPU 109 changes the relative relationship (relative position) between the image sensor 101 and the lens unit 100 (object image) (after changing the relative position), and performs storage and reading processing for the image sensor 101.

Next, in the step S1004, the CPU 109 generates the A image and the B image using the divided image generating circuit 102. Next, in the step S1005, the CPU 109 performs band-pass filter processing for the A image and the B image using the phase difference detecting accelerator circuit 103. Next, in the step S1006, the CPU 109 performs a correlation calculation between the A image and the B image using the phase difference detecting accelerator circuit 103. Next, in the step S1007, the CPU 109 evaluates the reliability as to whether the focus detection result is correct or not based on the information of the correlation calculation process and the calculated contrasts of the A image and the B image. Next, in the step S1008, the CPU 109 obtains the final focus detection result and ends the focus detection processing.

In this way, the CPU 109 drives the shift lens so as to change the relative relationship (relative position) in the optical-axis orthogonal direction between the shift lens and the image sensor 101 to the first position and the second position. Thus, even when the high-contrast position such as the eye of the object 410 illustrated in FIG. 4 and the phase difference detecting line 402 shift from each other and there is a frame that cannot be focused on the phase difference detecting line 402, the focus detection is available in the next frame or the like. Further, when the shift lens is always driven toward the high contrast line as in the operation mode C, the continuous focus detection is available by the phase difference method and the focusing operation can become stable.

While this embodiment describes that the shift lens is driven in the optical-axis orthogonal direction, the present invention is not limited to this embodiment and may drive the image sensor 101 in the optical-axis orthogonal direction so as to change the relative position between the imaging position of light from the lens unit 100 and the image sensor 101.

This embodiment can change the positional relationship between the object position and the phase difference detecting line by a zooming operation that changes the focal length or by driving the zoom lens in the lens unit 100 in the optical axis direction. Then, the relative position changes in the optical axis direction between the lens unit (optical system) 100 and the image sensor 101. Hence, the relative position may be changed at a timing (other than recording the image) different from the recording timing of the image so as to avoid the influence on the image, in particular, in the one shot AF and live-view without recording the image. Further, this embodiment can change the relative position every predetermined period such as every image frame (per frame rate).

This embodiment provides the image sensor 101 with a plurality of phase difference detecting lines at predetermined intervals (thinning intervals), but the present invention is not limited to this embodiment. For example, this embodiment is applicable to a configuration that provides a phase difference detecting pixel over the entire surface of the image sensor (so as to achieve the two-image division on the entire surface) and achieves the thinning reading due to factors such as the high frame rate scheme and image processing capability. Further, this embodiment provides the phase difference detecting lines thinned out in the vertical direction, but the present invention is not limited to this embodiment and may be applied to the phase difference detecting lines thinned out in the horizontal direction. In order to avoid a recorded image or a displayed image from shifting when the shift lens or the like is driven for the phase difference detection, a correction (by the electronic image stabilization) may be made which changes the position of the recorded image cut out of the overall image output from the image sensor by a shift amount and cuts the image. This embodiment can repetitively perform the focus detection on the object with a high accuracy.

### Second Embodiment

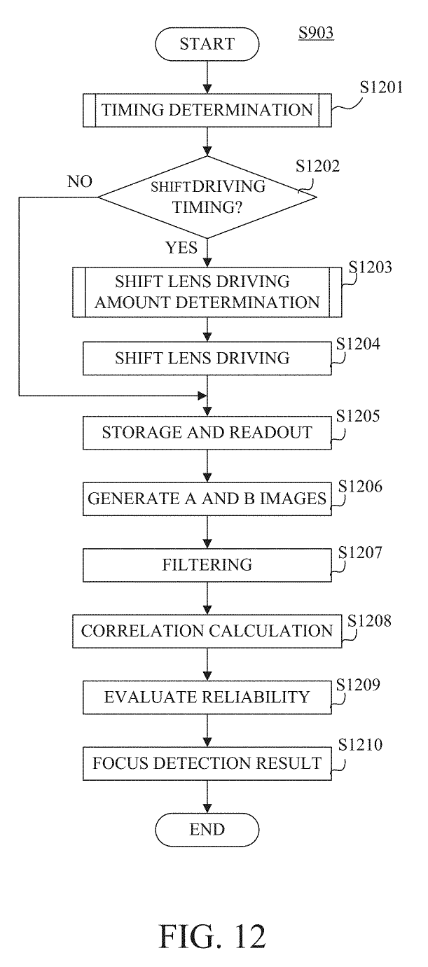

Referring now to FIG. 12, a description will be given of a second embodiment according to the present invention. FIG. 12 is a flowchart of focus detection processing (step S903 in FIG. 9). Each step in FIG. 12 is mainly executed by the CPU 109. The steps S1203 to S1210 in FIG. 12 are the same as the steps S1001 to S1208 in FIG. 10, respectively, and a description thereof will be omitted.

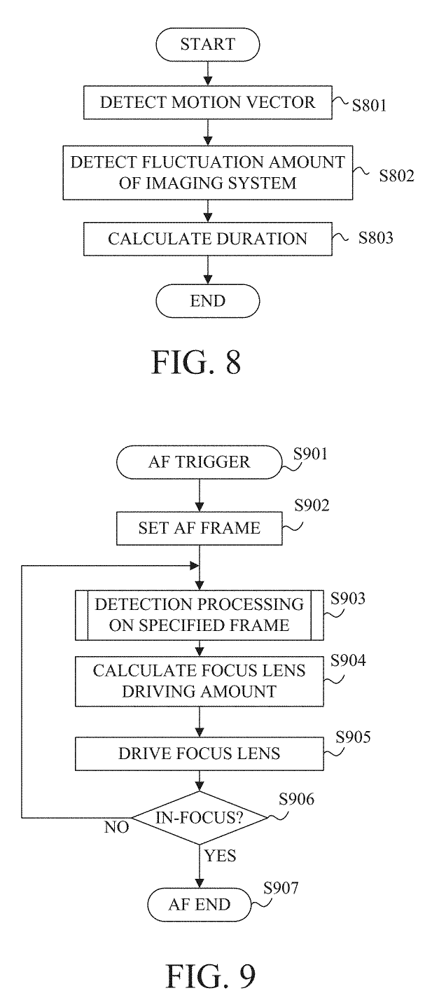

First, in the step S1201, the CPU 109 determines whether or not it is shift lens a driving timing. Referring now to FIG. 8, a description will be given of determination processing of the shift lens driving timing (timing determination processing). FIG. 8 is a flowchart of the timing determination processing. Each step in FIG. 8 is mainly executed by the CPU 109.

First, in the step S801, the CPU 109 detects a motion vector (motion vector information) based on captured latest image information (image signal). Next, in the step S802, the CPU 109 analyzes the output signal from the shake detecting sensor 113 and detects a fluctuation amount (shake information) of the imaging apparatus 10. Next, in the step S803, the CPU 109 calculates a duration for which the shift lens is not driven, based on the motion vector detected in the step S801 and the fluctuation amount of the imaging apparatus 10 detected in the step S802. This duration is a period that anticipates that the object area entering the phase difference detecting line changes in accordance with the movement of the object and the motion (each moving amount) of the imaging apparatus 10. In other words, for example, where the object and the imaging apparatus 10 fluctuate largely (where each moving amount is large), even if the shift lens and the image sensor 101 are not positively driven, a relationship changes between the object position and the phase difference detecting line. Hence, setting the duration can reduce the influence on the recorded image.

This embodiment converts each moving amount into the number of lines on a captured image, and sets a long duration (a period for which the shift lens is not driven) when a moving amount is equal to or larger than a predetermined amount. On the other hand, when the moving amount is small, a short duration is set. For example, when the moving amount is equal to or larger than the interval Wd between the phase difference detecting lines, the duration for which the shift lens is not driven is maintained. On the other hand, if the moving amount is less than half the interval Wd, the duration is maintained by a predetermined number of frames, such as three frames. When the moving amount is small, the shift lens is positively driven without setting the duration.

At the shift lens driving timing in the step S1201 in FIG. 12 (when there is no duration), the flow proceeds to the step S1203, and the CPU 109 performs the same processing as in the first embodiment. On the other hand, when it is not the shift lens driving timing (when there is a duration), the CPU 109 does not drive the shift lens (skipping the steps S1203 and S1204), proceeds to the step S1205, and then executes the same processing as in the first embodiment.

As described above, this embodiment aggressively captures the object and maintains the focus detection performance in the AF frame, even when the phase difference detecting lines are thinned out. In addition to the focus detection of the phase difference method, the contrast evaluation of the AF frame area of the image may be introduced to detect the object position, thereby improving the focus detection frequency by the phase difference method and continuing the accurate and fast focus detection processing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the embodiments, it is possible to provide a control apparatus, an imaging apparatus, a control method, and a storage medium capable of performing high-precision and high-speed focus detection.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-058643, filed on Mar. 26, 2018, which is hereby incorporated by reference herein in its entirety.

What is claimed is:

1. A control apparatus comprising:
a focus detector configured to perform a focus detection by a phase difference method based on an image signal output from an image sensor;
a driver configured to change a relative position between an imaging optical system and the image sensor in a direction orthogonal to an optical axis in the imaging optical system; and
a controller configured to control the focus detector and the driver so as to perform the focus detection by changing the relative position between the imaging optical system and the image sensor to each of a first position and a second position.

2. The control apparatus according to claim 1, wherein the driver changes the relative position by driving a shift lens in the imaging optical system.

3. The control apparatus according to claim 1, wherein the driver changes the relative position by driving the image sensor.

4. The control apparatus according to claim 1, wherein the driver changes the relative position in an optical axis direction.

5. The control apparatus according to claim 4, wherein the driver changes the relative position by driving a zoom lens in the imaging optical system.

6. The control apparatus according to claim 1, wherein the focus detector performs the focus detection based on the image signal obtained after the relative position is changed.

7. The control apparatus according to claim 1, wherein the driver changes the relative position when no image is recorded.

8. The control apparatus according to claim 1, wherein the driver changes the relative position every predetermined period.

9. The control apparatus according to claim 1, wherein when the driver changes the relative position, the controller performs an electronic image stabilization.

10. The control apparatus according to claim 1, wherein the driver changes a driving direction of the imaging optical system or the image sensor for each image frame.

11. The control apparatus according to claim 1, wherein the driver determines a driving amount and a driving direction of the imaging optical system or the image sensor based on a frame rate.

12. The control apparatus according to claim 1, further comprising a contrast evaluator configured to evaluate a contrast based on the image signal, wherein the controller controls the driver based on a contrast evaluation result by the contrast evaluator.

13. The control apparatus according to claim 1, wherein the controller determines a period for which the driver is not operated, based on at least one of motion vector information obtained based on the image signal and shake information of an imaging apparatus including the image sensor.

14. An imaging apparatus comprising:
an image sensor;
a focus detector configured to perform a focus detection by a phase difference method based on an image signal output from the image sensor;
a driver configured to change a relative position between an imaging optical system and the image sensor in a direction orthogonal to the optical axis of the imaging optical system; and
a controller configured to control the focus detector and the driver so as to perform the focus detection by changing the relative position between the imaging optical system and the image sensor to each of a first position and a second position.

15. A control method comprising the steps of:
changing a relative position between an imaging optical system and an image sensor; and
changing the relative position in a direction orthogonal to an optical axis in the imaging optical system to each of a first position and a second position and performing a focus detection by a phase difference method based on an image signal output form the image sensor.
